(19) United States
(12) Patent Application Publication
(10) Pub. No.: US 2005/0208833 A1
(43) Pub. Date: Sep. 22, 2005

(54) Locking terminator for CATV apparatus and method

(75) Inventor: Arkady Oksengorn, Boca Raton, FL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: EMERSON ELECTRONIC CONNECTOR AND COMPONENTS COMPANY, a Delaware Corp.

(21) Appl. No.: 10/801,801

(22) Filed: Mar. 16, 2004

(51) Int. Cl. H01R 13/60

(52) U.S. Cl. 439/620

(57) ABSTRACT

A locking terminator mechanism comprises a connector body with a novel protrusion, and a corresponding tool with a cavity. In a preferred embodiment the protrusion and the cavity each comprises a double D profile. The connector body's protrusion is configured to mate with the tool's cavity to allow selective locking and unlocking of the connector body to the CATV output port. The present invention also comprises a method for locking and unlocking a CATV connector from an output port.

### BACKGROUND OF THE INVENTION

1. Field of the Invention

The present invention relates generally to connectors and related apparatus and methods used in the transmission of electronic signals and, in particular, to tamper-resistant devices for terminating a connection in coaxial cable outlets and the like.

2. Discussion of the Related Art

Conventional cable television (CATV) signal transmission systems are organized with several individual end users connected to a single coaxial cable carrying a communication signal generated at a headend. Directional taps or similar devices are connected along the cable, and individual subscribers are then serviced with a coaxial cable drop line. Such devices typically utilize multiple output ports to efficiently provide service to many subscribers in the same area (e.g., within the same neighborhood, building, etc.). Each output port typically uses a female coaxial F-type plug connected to the subscriber's drop line.

Often, the number of output ports exceeds the actual number of subscribers being serviced. In these cases, it is desirable to terminate unused output ports (without connecting a drop line). Termination serves two principal functions, namely maintaining signal integrity and providing physical security. The use of terminators having impedances selected to match the impedance of the signal-carrying coaxial cable maintains signal quality. The presence of tamper-resistant terminators prevents unauthorized use of the cable signal by non-subscribers, who could otherwise simply pirate signals by attaching a drop line to any vacant output port.

Terminators might also be positioned between a previously-used output port and the corresponding drop line when the service to that particular subscriber is suspended; in this instance, service can be restored simply by removal of the interposed terminator without requiring that the full wiring to that subscriber be removed.

Several locking terminators are currently employed in connection with CATV systems and the like. Representative locking terminators are shown in U.S. Pat. Nos. 5,273,444, 5,106,312, 5,055,060, and 6,491,546, among others. These terminators utilize tools (typically hand held tools) which allow cable service providers to selectively lock and unlock the terminator. These “locking” terminators, of course, provide effective security only to the extent they prevent unauthorized access to the cable signal. Over time, however, the tools or devices used to lock and unlock the terminators become increasingly available to the public, allowing for easy unauthorized access to the cable signals. Unauthorized access is, of course, not only illegal but can also lead to diminished signal quality for the entire network, both of which are major concerns to the CATV industry. Public availability of prior tools is therefore highly problematic. These known devices typically utilize tools with moving parts, which are prone to fatigue and have high maintenance costs.

Therefore, a need exists for a locking terminator device which utilizes a locking mechanism heretofore unavailable. The present invention provides a unique solution having a novel locking mechanism, and an actuating tool without moving parts.

### SUMMARY OF THE INVENTION

Accordingly, the present invention comprises a locking terminator mechanism have a connector body with a novel locking mechanism having a protrusion and a corresponding cavity in a tool. The connector body's protrusion is configured to mate with the tool's cavity to allow selective locking and unlocking of the connector body to the CATV output port.

In a preferred embodiment the protrusion comprises a “double D” protrusion (defined below), and a corresponding tool with a “double D” cavity (defined below). The tool utilizes a unique design without moving parts. Together, the tool and the connector body provide an effective solution for CATV and related systems. The present invention also comprises a method for locking and unlocking a CATV connector from an output port.

These and other objects of the present invention will be classified in the following description of the preferred embodiment in connection with the drawings, the disclosure and the appended claims, wherein like reference numerals represent like elements throughout. The drawings constitute a part of this application and include exemplary embodiments of the present invention and illustrate various features thereof.

### BRIEF DESCRIPTION OF THE DRAWINGS

FIG. 1 is an exploded view illustrating an exemplary embodiment of a locking terminator of the present invention;

FIG. 2 is a partial sectional view of the locking terminator of FIG. 1, showing a tool thereof in an engaged position with a double D protrusion of the terminator's connector body body;

FIG. 3 is a front, elevational view of the double D protrusion of FIG. 2; and

FIG. 4 is a front, elevational view showing a double D cavity of the tool show in FIGS. 1 and 2.

FIGS. 5a and 5b illustrate an alternative embodiment of the present invention comprising a protrusion and corresponding cavity having triangular profiles.

FIGS. 6a and 6b illustrate an alternative embodiment of the present invention comprising a protrusion and a corresponding cavity having star-shaped profiles.

FIGS. 7a and 7b illustrate an alternative embodiment of the present invention comprising a protrusion and a corresponding cavity having hexagonal profiles.

### DETAILED DESCRIPTION OF THE PREFERRED EMBODIMENTS

While the present invention may be embodied in many different forms, there is shown in the drawings and discussed herein a few specific embodiments with the understanding that the present disclosure is to be considered only as an exemplification of the principles of the invention and is not intended to limit the invention to the embodiments illustrated.

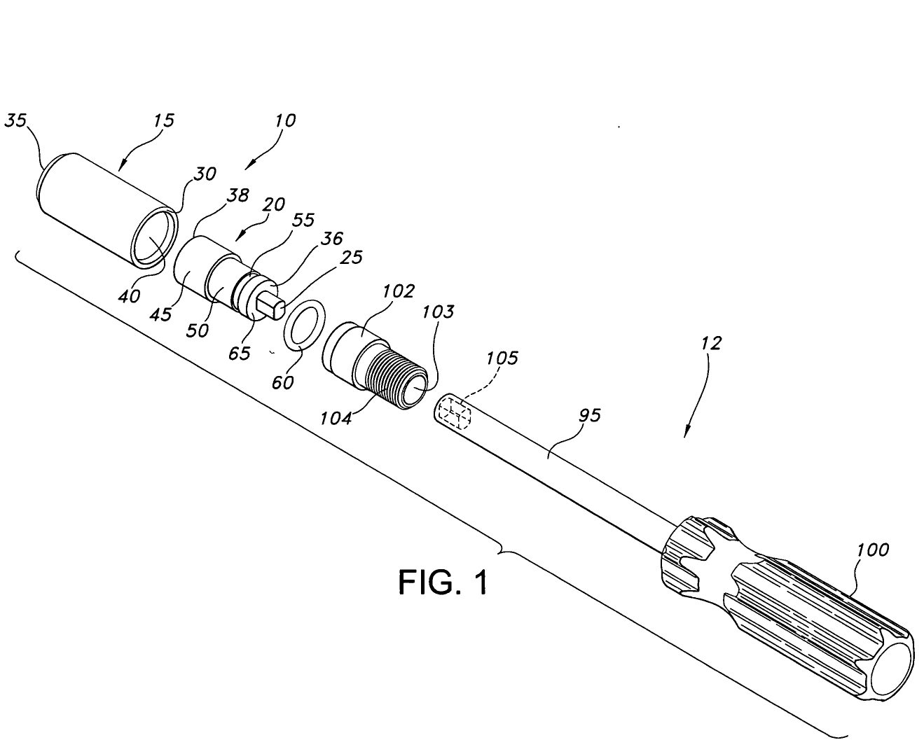

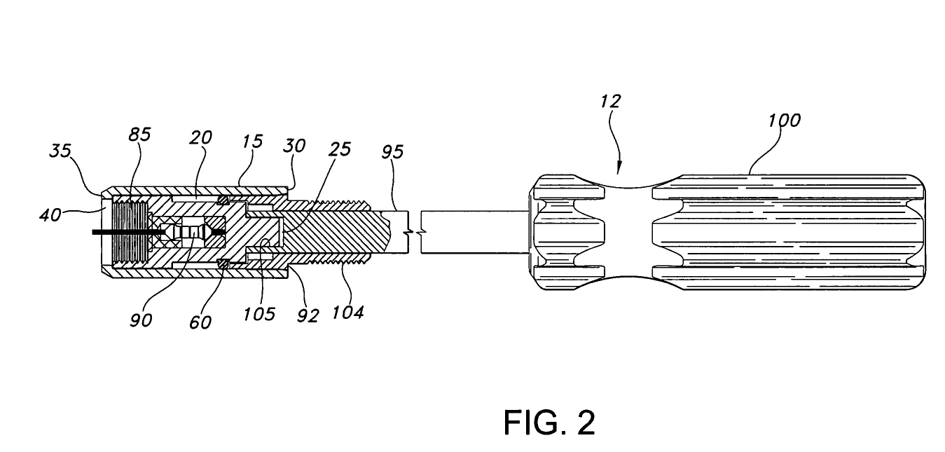

Referring to the drawings generally and FIGS. 1 and 2 in particular, the present invention comprises a locking terminator mechanism 10 for terminating a connection to a coaxial cable, and a mating tool 12 for selectively locking or unlocking the terminator 10.

Referring to FIG. 1, the terminator 10 generally comprises a housing 15, a connector body 20, and a protrusion or plug 25.

Housing 15 is generally cylindrical in shape with first and second ends 30, 35 and a bore extending longitudinally between the ends defining an open chamber 40. In a preferred embodiment, the housing 15 is formed from an aluminum alloy.

Connector body 20 is also generally cylindrical in shape with first and second ends 36, 38, and a first portion 45 of the connector body having a larger diameter than a second portion 50 thereof. In a preferred embodiment, the connector body 20 is formed from brass. A recess 55 is formed in the second portion 50 and is sized to receive a friction reducing device, such as an O-ring 60.

The connector body 20 also includes a front face 65 from which the plug 25 protrudes. In a preferred embodiment plug 25 is formed from an aluminum alloy. As best illustrated in FIGS. 1 and 3, plug 25 comprises a first and second opposed, flat surfaces 68, 70, and first and second opposed curved surfaces 75, 80. In a preferred embodiment the distance between the first and second flat surfaces 68, 70 surfaces is about 0.130 inches, and the curvature of the first and second opposed, curved surfaces 75, 80 is formed along a line corresponding about a 0.170 inch diameter circle formed about the midpoint of the front face 65.

As shown in FIG. 3, in a preferred embodiment the front profile of the plug 25 generally forms the shape of a first capital letter “D” positioned adjacent a second, inverted capital letter “D”. This profile of the plug 25 as illustrated in the drawings and described herein is referred to as a “double D” profile or protrusion.

Referring now to FIG. 2, connector body 20 is sized to be received within the chamber 40 (e.g., by snap-fitting) such that the housing 15 freely rotates or spins about the connector body 20. O-ring 60 is provided to center the connector body 20 within the housing 15 and to reduce friction and wear between the connector body and housing. Connector body 20 further comprises a securement mechanism such as a threaded F-type male connector 85 which, during operation, allows the connector body 20 to be affixed to an output port of the cable signal distribution system (not shown).

As illustrated in FIG. 2, the connector body 20 can also include a resistor 90 (such as a 75 Ohm resistor) or other electrical component for proper electrical termination of the coaxial cable signal.

Referring again to FIG. 2, in an assembled or operational configuration the connector body 20 is positioned within the housing 15 with the plug 25 fully contained within the housing 20. In a preferred embodiment the length of the connector body 20 from end to end is about 1.0 inch, and the length of the housing 15 from end to end is about 1.120 inches. Access to the plug 25 is limited to a small circumferential opening 92 formed by the positioning of the plug 25 within the chamber 40. The opening 92 is sized to restrict a person's hand or conventional tools from maintaining a grip on the plug 25, and thereby prevents the plug 25 from being turned without the use of the tool 12.

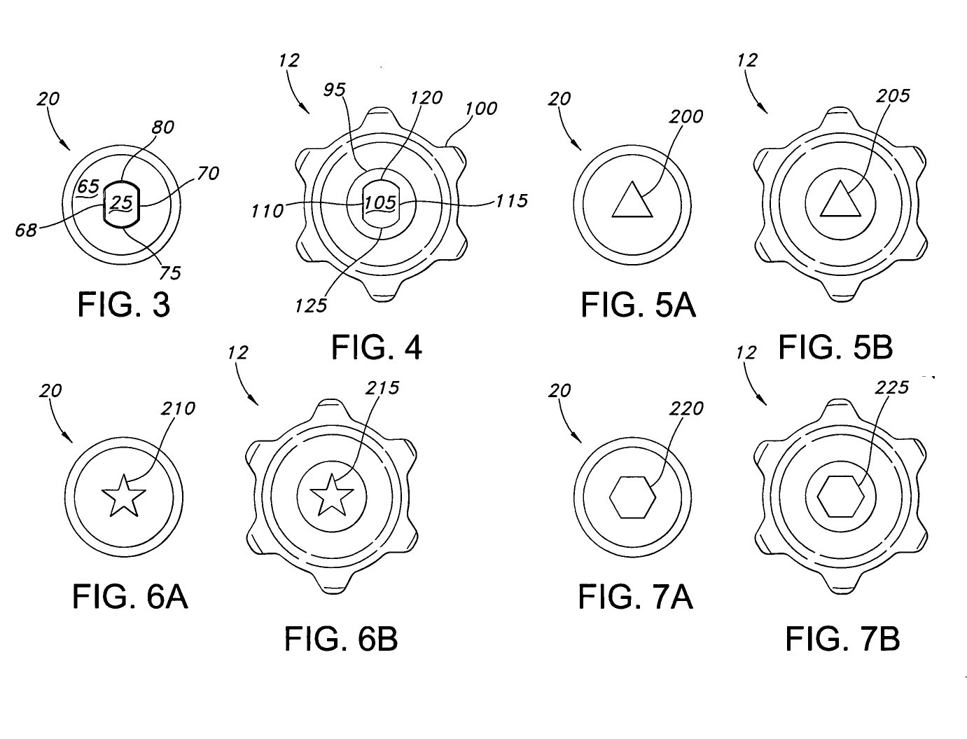

FIGS. 1 and 4 best illustrate the tool 12 of the present invention. The tool 12 generally comprises a cylindrical shaft 95, and a conventional handle 100 such as those commonly used with screwdrivers, ratchets and the like. In a preferred embodiment the shaft 95 is formed from steel.

As showing in FIGS. 1 and 4, in a preferred embodiment a knob 102 is fixedly secured to the shaft 95 to assist the operator in holding the tool 12. The knob 102 includes a bore 103 sized to receive the shaft 95 such that the front end of the shaft 95 extends through the knob 102 (see FIG. 2). A gripping surface 104 is provided on an outer portion of the knob 102 to allow a user to maintain a secure grip on the tool 12 during use.

Referring again to FIGS. 1 and 4, a cavity 105 is formed in the front end of the shaft 95. In a preferred embodiment the handle 100, shaft 95 and cavity 105 are integrally formed with no moving parts between the various components.

As best illustrated in FIG. 4, in a preferred embodiment the cavity 105 comprises first and second opposed, flat surfaces 110, 115, and first and second opposed curved surfaces 120, 125. The distance between the first and second flat surfaces 110.115 is about 0.135 inches, and the curvature of the first and second opposed, curved surfaces 120, 125 is formed along a line corresponding to about a 0.175 inch diameter circle formed about the midpoint of the shaft 95.

The front profile of the cavity 105 generally forms the shape of a first capital letter “D” positioned adjacent a second, inverted capital letter “D”. This profile of the cavity 105 as illustrated in the drawings and described herein is referred to as a “double D” profile or protrusion. As discussed more below, during operation the double D profile of the cavity 105 is configured to mate with the double D profile of the plug 25.

During operation, an authorized operator with the tool 12 can secure the connector body 20 to an output port (not shown). This is accomplished by providing torque to the plug 25 via the tool 12 by mating the cavity 105 with the plug 25 and rotating the tool 12 to secure connector 85 to a corresponding connector on the output port (not shown). FIG. 2 illustrates the configuration of the tool 12 when it is engaged with the plug 25. Upon application of a sufficient amount of torque the connector body 20 is effectively secured to the output port, which can be described as a locked configuration.

In the locked configuration application of a rotational force to the housing 15 (such as by a person seeking unauthorized access to the output port) merely results in rotation of the housing 15 about the connector body 20, leaving the connector body 20 secured to the output port.

Unlocking the mechanism to provide access to the output port requires use of the tool 12 to provide torque to the connector body 20 by mating the cavity 105 with the plug and rotating the tool 12 in the appropriate direction. Once the tool 12 has been sufficiently turned, the mechanism can be easily removed from the output port allowing access to the cable signal.

Although the foregoing description of the invention has been detailed with reference to one or more exemplary embodiments, i.e., the use a double D protrusion and a corresponding double D cavity, the present invention can also be configured with and includes protrusions and corresponding cavities formed in other shapes, profiles and configurations. For example, FIGS. 5a and 5b illustrate an alternative embodiment of the present invention comprising a protrusion 200 and corresponding cavity 205 having triangular profiles; FIGS. 6a and 6b illustrate an alternative embodiment of the present invention comprising a protrusion 210 and a corresponding cavity 215 having star-shaped profiles; and FIGS. 7a and 7b illustrate an alternative embodiment of the present invention comprising a protrusion 220 and a corresponding cavity 225 having hexagonal profiles. Other shapes, profiles and configurations of the protrusion and corresponding cavity can be utilized and are within the scope of the present invention.

Although it is believed to be apparent from the foregoing discussion the present invention also includes a method for locking and unlocking a CATV connector from an output port. The method comprises the steps of (a) providing a connector body having first and second ends, a securement mechanism at the first end for securing the connector body to an output port, and a protrusion formed at the second end, the connector body being configured to be positioned within a chamber such that the connector body freely rotates within the chamber; (b) providing a tool having a handle and a shaft with first and second ends, the shaft having a cavity formed in the first end; and (c) engaging the protrusion with the cavity and selectively rotating the connector body to lock or unlock the connector body from the output port.

Although the foregoing detailed description of the present invention has been described by reference to one or more exemplary embodiments, and the best mode contemplated for carrying out the present invention has been shown and described, it will be understood that modification or variations in the structure and arrangement of this embodiment other than those specifically set forth herein may be achieved by those skilled in the art and that such modifications are to be considered as being within the overall scope of the present invention. Therefore, it is contemplated to cover the present invention and any and all modifications, variations, equivalents that fall with in the true spirit and scope of the underlying principles disclosed and claimed herein. Consequently, the scope of the present invention is intended to be limited only by the attached claims.

1. A CATV locking terminator mechanism, comprising
a) a housing having a chamber extending through the housing;
b) a connector body having first and second ends, a front face, and a securement mechanism at the first end for securing the connector body to an output port, the connector body being configured to be positioned within the chamber such that the connector body freely rotates within the chamber; and
c) a protrusion formed at the front face for selective engagement with a cooperating tool to rotate the connector body with respect to the output port.

2. The CATV locking terminator mechanism of claim 1, wherein the protrusion comprises a double D profile.

3. The CATV locking terminator mechanism of claim 1, wherein the protrusion comprises a triangular profile.

4. The CATV locking terminator mechanism of claim 1, wherein the protrusion comprises a star shaped profile.

5. The CATV locking terminator mechanism of claim 1, wherein the protrusion comprises a hexagonal profile.

6. The CATV locking terminator mechanism of claim 2, wherein the double D protrusion comprises first and second opposed flat surfaces and first and second opposed curved surfaces.

7. The CATV locking terminator mechanism of claim 1, further comprising a recess formed in the connector body and an O-ring positioned within the recess.

8. The CATV locking terminator mechanism of claim 1, further comprising a resistor positioned within the connector body.

9. The CATV locking terminator mechanism of claim 6, wherein the distance between the first and second opposed flat surfaces is about 0.130 inches, and the curvature of the first and second opposed curved surfaces is formed along a line corresponding to about a 0.170 inch diameter circle formed about the midpoint of a front face of the protrusion.

10. The CATV locking terminator mechanism of claim 1, wherein the length of the connector body is about 1.0 inch and the length of the housing is about 1.120 inches.

11. The CATV locking terminator mechanism of claim 1, further comprising a circumferential opening formed between the protrusion and the housing and sized to restrict a person's hand or convention tools from maintaining a grip on the protrusion.

12. A tool for use with a CATV locking mechanism, comprising:
a) a handle;
b) a shaft having first and second ends; and
c) a cavity formed at the first end for selective engagement with a cooperating connector to selectively rotate the connector.

14. The tool of claim 13, wherein the cavity comprises a double D profile.

15. The tool of claim 13, wherein the cavity comprises a triangular profile.

16. The tool of claim 13, wherein the cavity comprises a star shaped profile.

17. The tool of claim 13, wherein the cavity comprises a hexagonal profile.

18. The tool of claim 14, wherein the double D cavity comprises first and second opposed flat surfaces and first and second opposed curved surfaces.

19. The tool of claim 13, further comprising a knob affixed to the shaft.

20. The tool of claim 18, wherein the distance between the first and second opposed flat surfaces is about 0.135 inches, and the curvature of the first and second opposed curved surfaces is formed along a line corresponding to about a 0.175 inch diameter circle formed about the midpoint of a front face of the shaft.

21. The tool of claim 19, further comprising a gripping surface formed along an outer portion of the knob.

22. A method for locking and unlocking a CATV connector from an output port, comprising:
a) providing a connector body having first and second ends, a front face, a securement mechanism at the first end for securing the connector body to an output port, and a protrusion formed at the front face, the connector body being configured to be positioned within a chamber such that the connector body freely rotates within the chamber;
b) providing a tool having a handle and a shaft with first and second ends, the shaft having a cavity formed in the first end; and
c) engaging the protrusion with the cavity and selectively rotating the connector body to lock or unlock the connector body from the output port.

23. The method of claim 22, wherein the protrusion and the cavity each comprises a double D profile.

24. The method of claim 22, wherein the protrusion and the cavity each comprises a triangular profile.

25. The method of claim 22, wherein the protrusion and the cavity each comprises a star shaped profile.

26. The method of claim 22, wherein the protrusion and the cavity each comprises a hexagonal profile.

27. The method of claim 23, wherein the double D protrusion comprises first and second opposed flat surfaces and first and second opposed curved surfaces.

28. The method of claim 22, further comprising a recess formed in the connector body and an O-ring positioned within the recess.

29. The method of claim 22, further comprising a resistor positioned within the connector body.

30. The method of claim 27, wherein the distance between the first and second opposed flat surfaces is about 0.130 inches, and the curvature of the first and second opposed curved surfaces is formed along a line corresponding to about a 0.170 inch diameter circle formed about the midpoint of the front face of the protrusion.

31. The method of claim 23, wherein the double D cavity comprises first and second opposed flat surfaces and first and second opposed curved surfaces.

32. The method of claim 22, further comprising a knob affixed to the shaft.

33. The method of claim 31, wherein the distance between the first and second opposed flat surfaces is about 0.135 inches, and the curvature of the first and second opposed curved surfaces is formed along a line corresponding to about a 0.175 inch diameter circle formed about the midpoint of a front face of the shaft.

34. The method of claim 32, further comprising a gripping surface formed along an outer portion of the knob.

35. The method of claim 22, wherein the length of the connector body is about 1.0 inch and the length of the housing is about 1.120 inches.

36. The method of claim 22, further comprising a circumferential opening formed between the protrusion and the housing and sized to restrict a person's hand or convention tools from maintaining a grip on the protrusion.
